(19) United States
(12) Patent Application Publication
(10) Pub. No.: US 2006/0075332 A1
(43) Pub. Date: Apr. 6, 2006

(54) System and method for information collation

(75) Inventors: William John Fairweather, Worcestershire (GB); Gary Paul Noble, Worcestershire (GB)

Correspondence Address: SCHMEISER, OLSEN + WATTS, 3 LEAR JET LANE, SUITE 201, LATHAM, NY, 12110, US

(73) Assignee: International Business Machines Corporation, Armonk, NY (US)

(21) Appl. No.: 10/549,210

(22) PCT Filed: Mar. 31, 2004
(86) PCT No.: PCT/GB04/01365

§ 371 Date: Sep. 14, 2005

(30) Foreign Application Priority Data
Apr. 3, 2003 (GB) 0307714.6

(51) Int. Cl. G06F 17/24; G06F 17/21; G06F 15/16

(52) U.S. Cl. 715/515; 715/513; 709/205

(57) ABSTRACT

A method and system for information collation through software code by a digital computer. The software code includes a collator. The collator receives first update information from a first user for updating a first topic portion of a first document with the first update information. The first topic portion has an associated first topic identified by a first topic identifier assigned to the first topic by a first template that the first document conforms to. The collator updates the first topic portion of the first document with the first update information based on the collator having determined that the first user has been assigned a project identifier that matches the project identifier of the project and that the first user has been assigned a topic identifier that matches the first topic identifier, which confirms the first user's authorization to have the first document updated with the first update information.

### FIELD OF THE INVENTION

This invention relates to information or data collation, and particularly (though not exclusively) to collation of information from multiple sources and media.

### BACKGROUND OF THE INVENTION

In today's business environment, information is needed rapidly, and is generally collected from multiple sources. Ideally the information is collated in realtime but the information could also be collated from an automated system. Normally, for high quality collated documents this means information being manually collated and integrated into a single view in a central location. However, as a result, this approach has the disadvantage(s) that the data is not available until the publish date and only the collator can see the full ‘picture’ as collation progresses.

A need therefore exists for a system and method for information collation wherein the abovementioned disadvantage(s) may be alleviated.

### DISCLOSURE OF THE INVENTION

In accordance with the present invention there is now provided a system for collation of information, the system comprising: store means for holding at least one document template and data for use therein; collator means coupled to the store means for collating information provided by one or more users; and communication means for communicating to one or more users a document collated from the document template and the information provided by one or more users.

Preferably the present invention provides for a system being arranged to respond in real-time to information provided by one or more users to communicate thereto the collated document.

Preferably the present invention provides for the communication means comprising a communication format adaptor.

Preferably the present invention provides for the communication format adaptor being arranged to adapt to at least one of services A-C: A an HTML service, B an email service, and C an XML service.

Preferably the present invention provides for a collator means comprising a document format adaptor.

Preferably the present invention provides for a document format adaptor being arranged to adapt to at least one of formats D-E: D HTML, and E PDF.

Preferably the present invention provides for a system to further comprise enquiry means for communicating an enquiry from a user to the collator means concerning an aspect of the collated information and for communicating the queried aspect to the user.

Viewed from another aspect the present invention provides for a method for collation of information, the method comprising: storing at least one document template and data for use therein; collating information provided by one or more users with at least one document template; and communicating to one or more users a document collated from the document template and the information provided by one or more users.

Preferably the present invention provides for a method wherein the step of communicating responds in real-time to information provided by one or more users to communicate thereto the collated document.

Preferably the present invention provides for a method wherein the step of communicating comprises adapting to a predetermined communication service.

Preferably the present invention provides for a method wherein the predetermined communication service comprises at least one of A-C: A an HTML service, B an email service, and C an XML service.

Preferably the present invention provides for a method wherein the step of collating comprises adapting the document to a predetermined document format.

Preferably the present invention provides for a method wherein the predetermined document format comprises at least one of formats D-E: D HTML, and E PDF.

Preferably the present invention provides for a method further comprising communicating an enquiry from a user concerning an aspect of the collated information and for communicating the queried aspect of the collated information to the user.

Viewed from another aspect the present invention provides for a computer program product directly loadable into the internal memory of a digital computer, comprising software code portions for performing the steps of any one of claim 8 to claim 14 when said product is run on a computer.

The invention, in a preferred embodiment, enables many users (people rather than real-time systems) to send information to a central collating sub-system that can then make the information available instantly in both a structured and unstructured manner and also via multiple distribution channels and media.

### BRIEF DESCRIPTION OF THE DRAWINGS

The invention will now be described by way of example only, with reference to the accompanying drawings, in which:

FIG. 1 shows a block schematic diagram illustrating the information collation system;

FIG. 2 shows a sample project plan used in meeting/conference-call preparation in the system of FIG. 1;

FIG. 3 shows a sample project template on which the document of FIG. 2 is based;

FIG. 4 shows a simple dialog illustrating how a user could update the status of an action in the sample project plan of FIG. 2;

FIG. 5 shows the sample project plan, based on that of FIG. 2, updated with information provided by a user; and

FIG. 6 shows a simple dialog illustrating how an authorised user can also extract information on a given topic in a given project in the system of FIG. 1.

### DETAILED DESCRIPTION OF THE PREFERRED EMBODIMENTS OF THE INVENTION

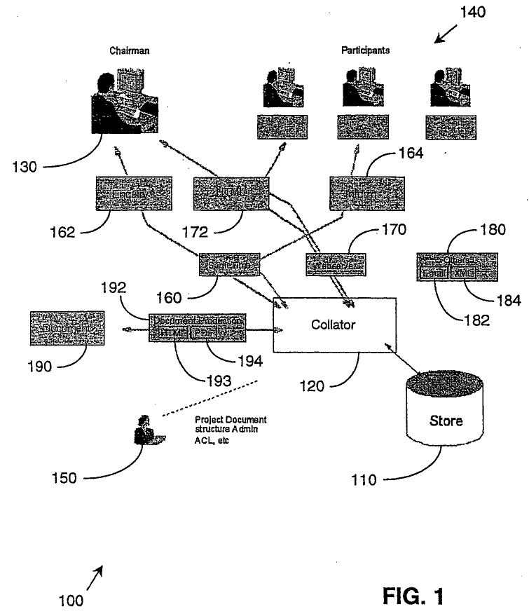

Referring firstly to FIG. 1, a real-time information collation system 100 provides online/offline document/status information in a structured manner. The system 100 includes:
a store 110—holds data and document templates
a collator 120—handles input of information and requests for information from multiple sources and media as well as the generation of output documentation
a chairman 130—the overall project controller who has full access to all project topics
one or more participants 140—all other participants on the project
a project document structure administrator 150—responsible for design of output document templates and for determination of access control lists (ACL), etc.

The elements 110-150 of the system are conveniently linked via intranet or internet. The store 110 and collator 120 form a collation/storage sub-system. The system 100 also includes a ‘same-time robot’ 160. (a semi-intelligent instant messaging client—known per se—that can both receive structured messages from and send messages to, other instant message users) for automating information transfer between the collator 120 and the chairman 130 or the other participants 140—enquiries (via Enquiry interface 162) or information provided (via Inform interface 164) between the collator 120 and the chairman or the other participants. The system 100 also includes an HTML (HyperText Markup Language) web server 170 for communicating information (via HTML interface 172) between the collator 120 and the chairman or the other participants. Other messaging services (shown as collectively as 180, which may utilise a desired adaptor such as an email adaptor 182, an XML—Extensible Markup Language—adaptor 184, etc., to adapt information into a desired format) may be used if desired to communicate information between users 130 & 140 and the collation/storage sub-system 110 & 120.

A document 190 containing the collated information is produced from the collator 120 (via document production interface 192, which may utilise a desired adaptor, e.g., an HTML adaptor 193, a PDF—Portable Document Format—adaptor 194, etc., to adapt the document into a desired format) based on a predetermined document template. It will be understood that the document template may conveniently be generated using common word-processing software, and the information may conveniently be stored in the form of a database or spreadsheet, as desired.

### EXAMPLE 1

### Meeting/Conference-Call Preparation

In use of the system 100 to prepare for a meeting or telephone conference call between a number of participants, the participants are required to provide information prior to the actual meeting for a project plan—status updates, technical information, estimates, etc.

Equally, during the call participants may want to discuss and update project status during the call.

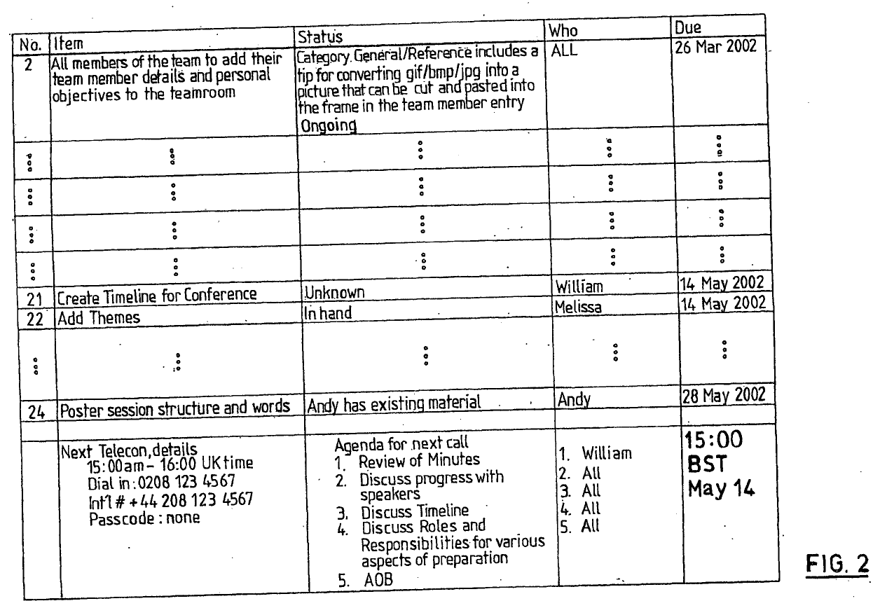

FIG. 2 shows a sample project plan, collated from information provided by different participants.

The system 100 enables participants to enter details either just before the call or as the call progresses. The updates will be visible immediately in the updated project plan.

The system 100 enables a document (HTML, PDF (portable document format), etc.) to be structured (via a template) and be dynamically rebuilt by a collator mechanism when changes are identified. Users are assigned to ‘Projects ID’ and ‘Topics ID’ s' and are able to send in textual information via an online mechanism direct to the collator. The collator checks the authority of the user against the project and topic and if valid accepts the new information and refreshes the contents of the documents.

The collator also verifies that the content has been provided as appropriate (e.g., in due time), and if not generates an outbound real-time request/reminder for information, subject to certain criteria and rules (which need not be described in further detail herein).

The users (chairman 130 or other participants 140) can review the document by refreshing the document display (if via a browser) or querying the collator for a specific project and topic (as will be explained in greater detail below). The document can be viewed on-line as described, or off-line, as desired.

Referring to the example shown in FIG. 2, each row of the document template refers to an item of information (referred to hereafter as an action) related to the meeting/conference-call: the action number, a description of the item, the status of the item, who is affected by the action, and when the action is/was due. Each of these except the first can be updated by users.

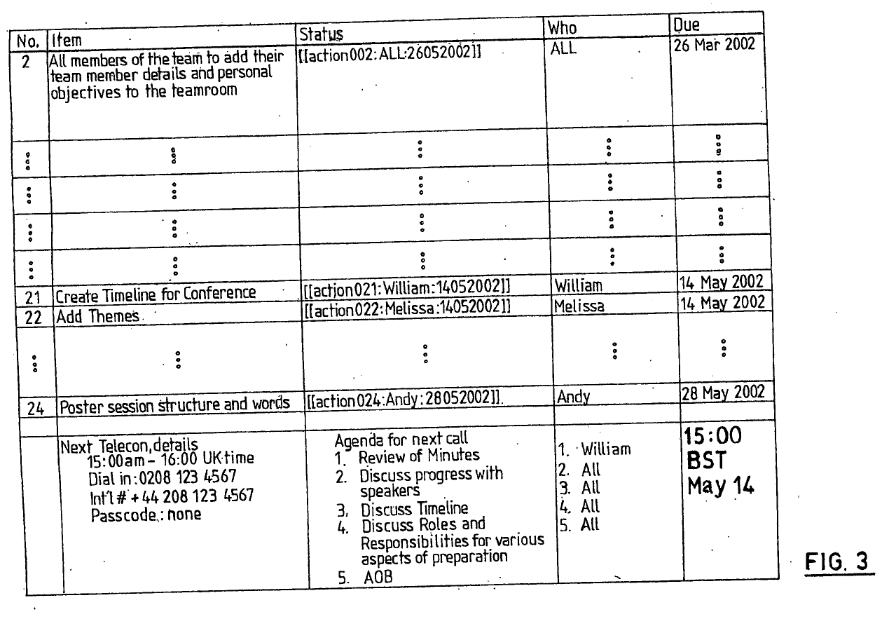

FIG. 3 shows a document template (on which the document of FIG. 2 is based) as it might be seen in an editor. Entries in the status column are of the format:
[[topicID:user access list:due date]].

Using a format such as this allows control of who can access a topic (one, many or all users assigned to a project) and when the update is due.

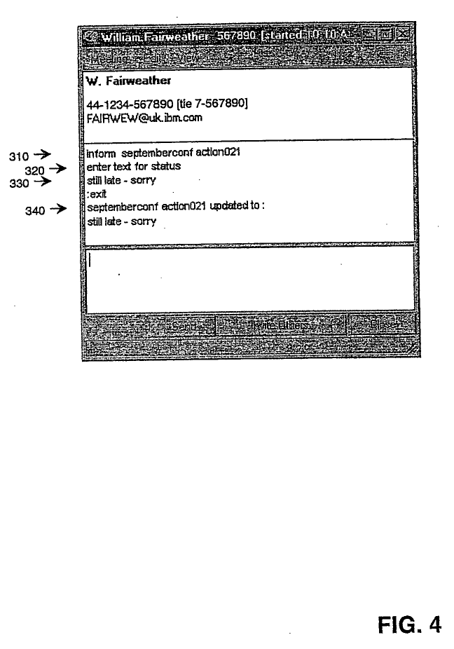

FIG. 4 shows a simple dialog illustrating how a user “William” could update the status of action 21 as shown in FIG. 2. Here the information collation system is through the same-time robot 160.

Referring now to FIG. 4, firstly, William asks (at 310) to inform project ‘septemberconf’ about topic ‘action021’.

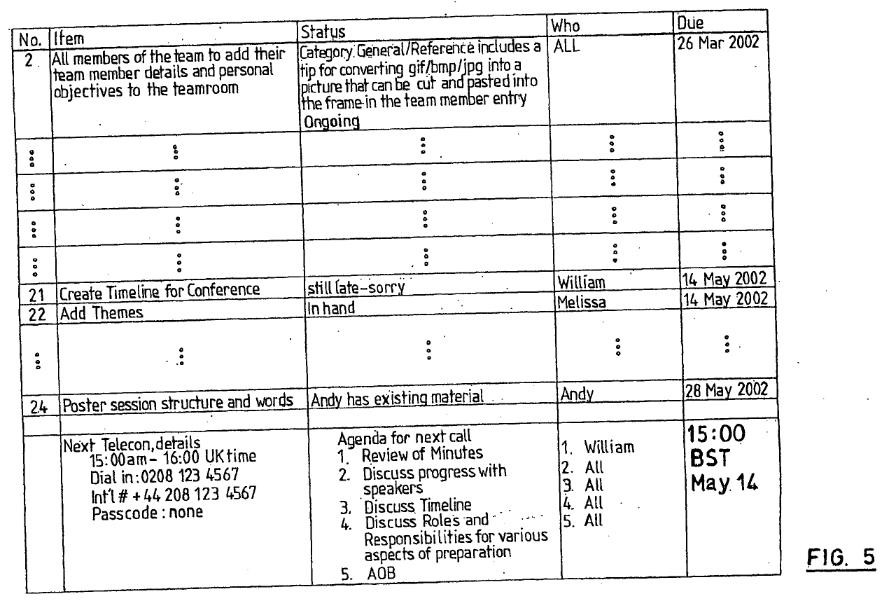

The robot responds (at 320) asking for the status update. William enters (at line 330) the status text update (“still late—sorry”), and the robot responds (at line 340) saying that the update has been made. At this point the project plan will instantly have been updated with the new information for all participants to see (see FIG. 5, which shows that the status text for action 21 has been appropriately updated).

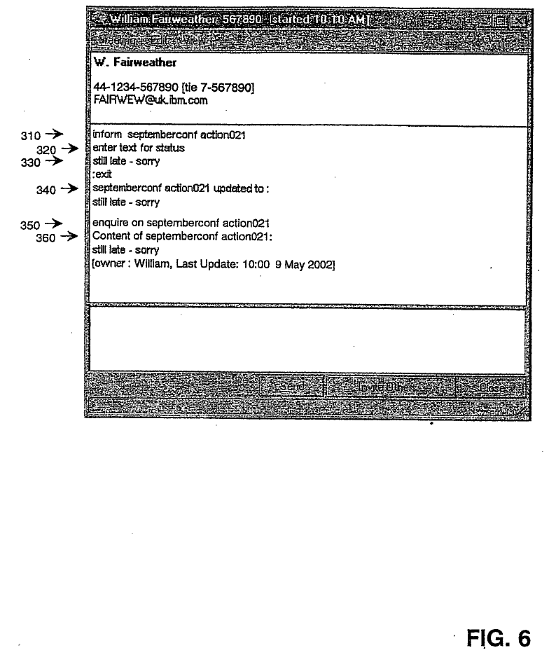

FIG. 6 shows how an authorised user might also be able to extract information on a given topic in a given project using the same same-time robot. As illustrated in FIG. 6, after updating the status information for action 21 as described above in relation to FIG. 4, William enters (at 350) a request to ‘enquire on’ ‘action021’ of project ‘septemberconf’. The robot then responds to William by displaying the content of the enquired action, and also indicates the information owner and the time and date of last update.

It will be understood that the dialogs shown in FIG. 4 and FIG. 5 are based on well-known instant messaging services, which need not be described herein in greater detail.

### EXAMPLE 2

### Meeting Minutes

It will be understood that similarly after a meeting, the minutes will generally have action points assigned to various attendees. The system 100 could be used to firstly generate the minutes in an accepted format (based on a different template document—not shown) and then act as a tool for keeping the status of action points up to date and issue reminders if an action point is not acted upon at a required time.

It will be appreciated that a system such as this can be used to enable simple updates via easy-to-use tools to position information on many systems in real-time. It can also enable rapid review of basic facts on a project. Such tools may include same-time services, HTML forms, PDF, etc.

It will be appreciated that the mechanism described above for information collation may be carried out in software running on processors (not shown), and that the software may be provided as a computer program element carried on any suitable data carrier (also not shown) such as a magnetic or optical computer disc.

It will be understood that the real-time mechanism to provide on-line/off-line document/status information in a structured manner described above provides the following advantages:

Allows many people in real time to enter or replace information into the system for immediate refresh and display to all interested parties (currently collation of information is a central, and often largely manual, process that cannot be displayed and managed all at once via many different media in real-time).

Structure and format of output is separate from the collation process.

1-16. (canceled)

17. A method for information collation relating to a plurality of documents of a project having a project identifier, each document of the plurality of documents having a plurality of topic portions therein, each topic portion of each document being associated with a topic, each document conforming to an associated template that assigns a topic identifier to each topic of each topic portion of said each document, each topic portion of each document adapted to be updated by only those individuals having been assigned a project identifier that matches the project identifier of the project and having been assigned a topic identifier that matches the topic identifier of the topic associated with the topic portion of said each document, said method implemented through execution of software code by a digital computer, said software code comprising a collator, said method comprising:
receiving, by the collator, first update information from a first user for updating a first topic portion of a first document of the plurality of documents with the first update information, said first topic portion having an associated first topic identified by a first topic identifier assigned to the first topic by a first template that the first document conforms to; and
updating, by the collator, the first topic portion of the first document with the first update information based on the collator having determined that the first user has been assigned a project identifier that matches the project identifier of the project and that the first user has been assigned a topic identifier that matches the first topic identifier, which confirms the first user's authorization to have the first document updated with the first update information.

18. The method of claim 17, wherein the software code further comprises a same-time robot, wherein the collator and the robot are distinct software components of the software code, and wherein the method further comprises:
receiving, by the robot, a second update request from a second user for updating a second topic portion of a second document of the plurality of documents with second update information, said second topic portion having an associated second topic identified by a second topic identifier assigned to the second topic by a second template that the second document conforms to;
determining, by the collator, that the second user has been assigned a project identifier that matches the project identifier of the project and that the second user has been assigned a topic identifier that matches the second topic identifier, which confirms the second user's authorization to have the second document updated with the second update information;
asking, by the robot, the second user to provide the second update information, said asking being performed after the robot has received the second update request and after the collator has confirmed the second user's authorization to have the second update made in the second document;
receiving, by the robot from the second user, the second update information in response to said asking; and
updating, by the robot, the second topic portion of the second document with the received second update information.

19. The method of claim 18, wherein the method further comprises after said updating the second topic portion of the second document with the second update information:
displaying, by the robot, a message comprising the second update information and an indication that the second topic portion of the second document has been updated with the second update information.

20. The method of claim 18, wherein the first and second topic respectively pertain to a first and second work item of the project, and wherein the second update information is an update of a status of the second work item.

21. The method of claim 20, wherein the method further comprises after said updating the second topic portion of the second document with the second update information:
receiving, by the robot, an enquire request for display of the status of the second work item; and
responsive to receiving the enquire request: displaying, by the robot, a message comprising the status of the second work item and further comprising a time and date of a last update of the status of the second work item.

22. The method of claim 18, wherein said receiving the second update request, said asking, said receiving the second update information, and said updating the second topic portion of the second document are performed in real time by the robot during a meeting that includes a plurality of participants, and wherein the plurality of participants comprise the second user.

23. The method of claim 22, wherein the plurality of participants include a chairman, and wherein the chairman has full access to the plurality of topic portions of the document.

24. The method of claim 22, wherein the meeting is a conference call.

25. A computer program product, comprising software code loadable into an internal memory of a digital computer, said software code when executed on the computer performs a method for information collation relating to a plurality of documents of a project having a project identifier, each document of the plurality of documents having a plurality of topic portions therein, each topic portion of each document being associated with a topic, each document conforming to an associated template that assigns a topic identifier to each topic of each topic portion of said each document, each topic portion of each document adapted to be updated by only those individuals having been assigned a project identifier that matches the project identifier of the project and having been assigned a topic identifier that matches the topic identifier of the topic associated with the topic portion of said each document, said method implemented through execution of software code by a digital computer, said software code comprising a collator, said method comprising:
receiving, by the collator, first update information from a first user for updating a first topic portion of a first document of the plurality of documents with the first update information, said first topic portion having an associated first topic identified by a first topic identifier assigned to the first topic by a first template that the first document conforms to; and
updating, by the collator, the first topic portion of the first document with the first update information based on the collator having determined that the first user has been assigned a project identifier that matches the project identifier of the project and that the first user has been assigned a topic identifier that matches the first topic identifier, which confirms the first user's authorization to have the first document updated with the first update information.

26. The computer program product of claim 25, wherein the software code further comprises a same-time robot, wherein the collator and the robot are distinct software components of the software code, and wherein the method further comprises:
receiving, by the robot, a second update request from a second user for updating a second topic portion of a second document of the plurality of documents with second update information, said second topic portion having an associated second topic identified by a second topic identifier assigned to the second topic by a second template that the second document conforms to;
determining, by the collator, that the second user has been assigned a project identifier that matches the project identifier of the project and that the second user has been assigned a topic identifier that matches the second topic identifier, which confirms the second user's authorization to have the second document updated with the second update information;
asking, by the robot, the second user to provide the second update information, said asking being performed after the robot has received the second update request and after the collator has confirmed the second user's authorization to have the second update made in the second document;
receiving, by the robot from the second user, the second update information in response to said asking; and
updating, by the robot, the second topic portion of the second document with the received second update information.

27. The computer program product of claim 26, wherein the method further comprises after said updating the second topic portion of the second document with the second update information:
displaying, by the robot, a message comprising the second update information and an indication that the second topic portion of the second document has been updated with the second update information.

28. The computer program product of claim 26, wherein the first and second topic respectively respectively pertain to a first and second work item of the project, and wherein the second update information is an update of a status of the second work item.

29. The computer program product of claim 28, wherein the method further comprises after said updating the second topic portion of the second document with the second update information:
receiving, by the robot, an enquire request for display of the status of the second work item; and
responsive to receiving the enquire request: displaying, by the robot, a message comprising the status of the second work item and further comprising a time and date of a last update of the status of the second work item.

30. The computer program product of claim 26, wherein said receiving the second update request, said asking, said receiving the second update information, and said updating the second topic portion of the second document are performed in real time by the robot during a meeting that includes a plurality of participants, and wherein the plurality of participants comprise the second user.

31. A system comprising a computer and software code loadable into an internal memory of the computer, said software code when executed on the computer performs a method for information collation relating to a plurality of documents of a project having a project identifier, each document of the plurality of documents having a plurality of topic portions therein, each topic portion of each document being associated with a topic, each document conforming to an associated template that assigns a topic identifier to each topic of each topic portion of said each document, each topic portion of each document adapted to be updated by only those individuals having been assigned a project identifier that matches the project identifier of the project and having been assigned a topic identifier that matches the topic identifier of the topic associated with the topic portion of said each document, said method implemented through execution of software code by a digital computer, said software code comprising a collator, said method comprising:
receiving, by the collator, first update information from a first user for updating a first topic portion of a first document of the plurality of documents with the first update information, said first topic portion having an associated first topic identified by a first topic identifier assigned to the first topic by a first template that the first document conforms to; and
updating, by the collator, the first topic portion of the first document with the first update information based on the collator having determined that the first user has been assigned a project identifier that matches the project identifier of the project and that the first user has been assigned a topic identifier that matches the first topic identifier, which confirms the first user's authorization to have the first document updated with the first update information.

32. The system of claim 31, wherein the software code further comprises a same-time robot, wherein the collator and the robot are distinct software components of the software code, and wherein the method further comprises:
receiving, by the robot, a second update request from a second user for updating a second topic portion of a second document of the plurality of documents with second update information, said second topic portion having an associated second topic identified by a second topic identifier assigned to the second topic by a second template that the second document conforms to;
determining, by the collator, that the second user has been assigned a project identifier that matches the project identifier of the project and that the second user has been assigned a topic identifier that matches the second topic identifier, which confirms the second user's authorization to have the second document updated with the second update information;
asking, by the robot, the second user to provide the second update information, said asking being performed after the robot has received the second update request and after the collator has confirmed the second user's authorization to have the second update made in the second document;
receiving, by the robot from the second user, the second update information in response to said asking; and
updating, by the robot, the second topic portion of the second document with the received second update information.

33. The system of claim 32, wherein the method further comprises after said updating the second topic portion of the second document with the second update information:
displaying, by the robot, a message comprising the second update information and an indication that the second topic portion of the second document has been updated with the second update information.

34. The system of claim 32, wherein the first and second topic respectively pertain to a first and second work item of the project, and wherein the second update information is an update of a status of the second work item.

35. The system of claim 34, wherein the method further comprises after said updating the second topic portion of the second document with the second update information:
receiving, by the robot, an enquire request for display of the status of the second work item; and
responsive to receiving the enquire request: displaying, by the robot, a message comprising the status of the second work item and further comprising a time and date of a last update of the status of the second work item.

36. The system of claim 32, wherein said receiving the second update request, said asking, said receiving the second update information, and said updating the second topic portion of the second document are performed in real time by the robot during a meeting that includes a plurality of participants, and wherein the plurality of participants comprise the second user.
